(19) United States
(12) Patent Application Publication
(10) Pub. No.: US 2026/0039181 A1
(43) Pub. Date: Feb. 5, 2026

(54) CONTROL CIRCUIT AND METHOD FOR REDUCING REVERSE RECOVERY CHARGE IN SWITCHING POWER CONVERTER

(71) Applicant: Richtek Technology Corporation, Zhubei City (TW)

(72) Inventors: Ta-Yung Yang, Taoyuan (TW); Kuo-Chi Liu, Hsinchu (TW)

(21) Appl. No.: 19/268,332

(22) Filed: Jul. 14, 2025

Related U.S. Application Data
(60) Provisional application No. 63/676,926, filed on Jul. 30, 2024.

(30) Foreign Application Priority Data
Feb. 21, 2025 (TW) 114106611

(51) Int. Cl. H02M 1/00; H02M 3/158

(52) U.S. Cl. CPC H02M 1/0051; H02M 3/158

(57) ABSTRACT

A control circuit for reducing reverse recovery charge in a switching converter includes a first control signal configured to switch a first transistor, a second control signal configured to switch a second transistor, and an auxiliary control signal configured to switch an auxiliary transistor. A first terminal and a second terminal of the first transistor are coupled in parallel to a first terminal and a second terminal of the auxiliary transistor. The first transistor and the second transistor are coupled to a switching node, configured to periodically switch an inductor to convert an input voltage into an output voltage. A delay time exists between the time when the auxiliary control signal is deactivated and the time when the first control signal is deactivated. The auxiliary control signal is deactivated after the second control signal is activated.

### CROSS REFERENCE

The present invention claims priority to the provisional application Ser. No. 63/676,926, filed on Jul. 30, 2024 and claims priority to the TW patent application No. 114106611, filed on Feb. 21, 2025.

### BACKGROUND OF THE INVENTION

### Field of Invention

The present invention relates to a control circuit. Particularly it relates to a control circuit for reducing reverse recovery charge in switching power converter. The present invention also relates to a control method for reducing reverse recovery charge in switching power converter.

### Description of Related Art

FIG. 1 illustrates a prior art switching converter. As shown in FIG. 1, when a high-side transistor 42 is turned on according to a related signal of a control signal SH, an inductor 30 charges an output capacitor through a switching node LX, thereby generating an output voltage VO. When the high-side transistor 42 is turned off, a low-side transistor 41 is turned on according to a related signal of a control signal SL, such that a current of the inductor 30 flows through the low-side transistor 41.

During a dead time that precedes the next switching cycle, both the high-side transistor 42 and the low-side transistor 41 are turned off, and the current of the inductor 30 flows through a body diode 43 inside the low-side transistor 41. When the next switching cycle begins, the high-side transistor 42 turns on and applies a rapidly changing reverse voltage to the body diode 43. The transition of the body diode 43 from its forward-conducting state during the dead time to a reverse-blocking state requires a large amount of reverse recovery charge. This reverse recovery charge, in conjunction with parasitic inductance, results in a voltage spike of a switching voltage at the switching node LX. The voltage spike may exceed the rated voltage of the low-side transistor 41, the high-side transistor 42, or other components, thereby degrading reliability or even causing device failure.

A prior-art switching converter 1001 suppresses the voltage spike of the switching voltage at the switching node LX by means of a filter circuit formed by the capacitor 81 and a resistor 82. However, while the resistor 82 attenuates the voltage spike, it also introduces power loss, and a parasitic inductance 91 may further degrade the suppression effect of the filter circuit.

In view of the foregoing, and to overcome drawbacks of the prior art, the present invention provides a control circuit for reducing reverse recovery charge in a switching converter.

### SUMMARY OF THE INVENTION

From one perspective, the present invention provides a control circuit for reducing reverse recovery charge in a switching converter, comprising: a first control signal configured to switch a first transistor; a second control signal configured to switch a second transistor; and an auxiliary control signal configured to switch an auxiliary transistor; wherein a first terminal and a second terminal of the first transistor are coupled in parallel to a first terminal and a second terminal of the auxiliary transistor; wherein the first transistor and the second transistor are coupled to a switching node and configured to periodically switch an inductor so as to convert an input voltage into an output voltage; and wherein a delay time elapses from disabling the first control signal to disabling the auxiliary control signal, and the auxiliary control signal is disabled after the second control signal is enabled.

In one embodiment, the first transistor, the second transistor, and the auxiliary transistor are integrated in a single chip.

In one embodiment, the control circuit further comprises: a delay circuit configured to delay the first control signal so as to generate the auxiliary control signal with the delay time.

In one embodiment, the delay time is determined according to a delay resistor.

In one embodiment, the first transistor and the auxiliary transistor are formed on a same substrate, and the first transistor and the auxiliary transistor respectively correspond to respective portions of a transistor array on the substrate.

In one embodiment, an on-resistance value of the auxiliary transistor is at least five times greater than an on-resistance value of the first transistor.

In one embodiment, the control circuit further comprises: a non-overlap circuit configured to generate a dead time between the first control signal and the second control signal, wherein both the first control signal and the second control signal are disabled during the dead time.

In one embodiment, the first transistor, the second transistor, and the inductor are configured as one of: a synchronous buck converter, a synchronous boost converter, or a buck-boost converter.

In one embodiment, an on-resistance value of the auxiliary transistor is less than an upper resistance limit, thereby preventing a body diode of the first transistor from conducting.

In one embodiment, an on-resistance value of the auxiliary transistor is greater than a lower resistance limit such that a current flowing through the auxiliary transistor is less than a predetermined current value.

In one embodiment, an on-resistance value of the auxiliary transistor is inversely related to a reverse recovery charge value of a body diode of the first transistor.

In one embodiment, the auxiliary control signal is disabled after the second control signal is enabled, so as to avoid or reduce an effect of reverse recovery charge of a body diode of the first transistor.

In one embodiment, a transition time of a switching voltage at the switching node is shortened due to avoidance or reduction of reverse recovery charge of the body diode.

In one embodiment, a switching voltage at the switching node transitions in response to the second control signal being enabled, and the auxiliary control signal is disabled when the switching voltage exceeds a predetermined threshold.

In one embodiment, the delay circuit further includes: a control transistor configured to switch when the switching voltage exceeds the predetermined threshold so as to disable the auxiliary control signal.

In one embodiment, the control transistor is coupled to a control terminal of the auxiliary transistor, the control transistor is controlled by the switching voltage, and the predetermined threshold corresponds to a gate-to-source threshold voltage of the control transistor.

In one embodiment, the delay circuit further includes: a voltage-clamp transistor coupled between the control transistor and the switching voltage and configured to clamp a voltage at a control terminal of the control transistor, thereby preventing the voltage at the control terminal from exceeding a clamp voltage.

From another perspective, the present invention provides a control method for reducing reverse recovery charge in a switching converter, comprising: generating a first control signal configured to switch a first transistor; generating a second control signal configured to switch a second transistor; generating an auxiliary control signal configured to switch an auxiliary transistor, wherein a first terminal and a second terminal of the first transistor are coupled in parallel to a first terminal and a second terminal of the auxiliary transistor; periodically switching an inductor according to the first control signal and the second control signal so as to convert an input voltage into an output voltage; and controlling such that a delay time elapses from disabling the first control signal to disabling the auxiliary control signal, and disabling the auxiliary control signal after the second control signal has been enabled.

The present invention couples an auxiliary transistor in parallel with a first transistor (the low-side transistor). According to the present invention, after a first control signal that controls the first transistor is disabled, the auxiliary transistor remains on for a delay time, allowing the inductor current to flow through the auxiliary transistor and thereby preventing or reducing the accumulation of reverse-recovery charge. The auxiliary transistor of the present invention is turned off once a second transistor (the high-side transistor) is enabled, thus avoiding or reducing the voltage spike caused by reverse-recovery charge in the prior art. Furthermore, the switching converter according to the present invention can adaptively adjust the delay time to further reduce losses.

The objectives, technical details, features, and effects of the present invention will be better understood with regard to the detailed description of the embodiments below, with reference to the attached drawings.

### BRIEF DESCRIPTION OF THE DRAWINGS

FIG. 1 illustrates a prior-art switching converter.

FIG. 2 illustrates a schematic diagram of a switching converter in one embodiment of the present invention.

FIG. 3 illustrates operating waveforms of the control circuit in one embodiment of the present invention.

FIG. 4 illustrates a circuit block diagram of a switching converter in one embodiment of the present invention.

FIG. 5 illustrates a circuit block diagram of a switching converter in another embodiment of the present invention.

FIG. 6 illustrates a schematic diagram of a switching converter in a specific embodiment of the present invention.

FIG. 7 illustrates operating waveforms of the control circuit corresponding to FIG. 6 in one embodiment of the present invention.

FIG. 8 illustrates a schematic diagram of a switching converter in another specific embodiment of the present invention.

FIG. 9 illustrates operating waveforms of the control circuit corresponding to FIG. 8 in one embodiment of the present invention.

FIGS. 10A to 10G illustrate various embodiments of a power-stage circuit of the switching converter of the present invention.

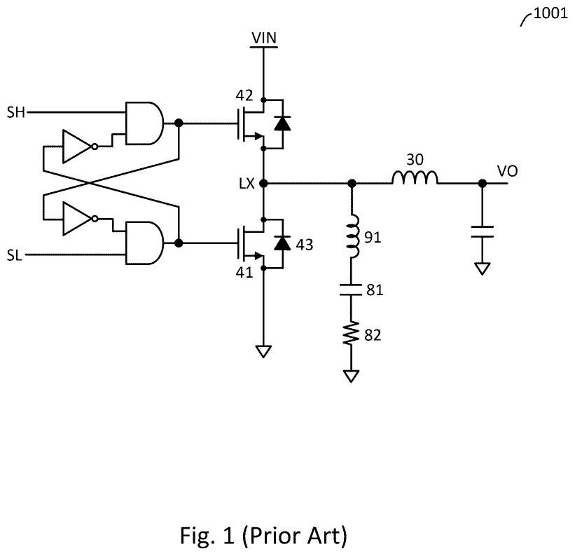

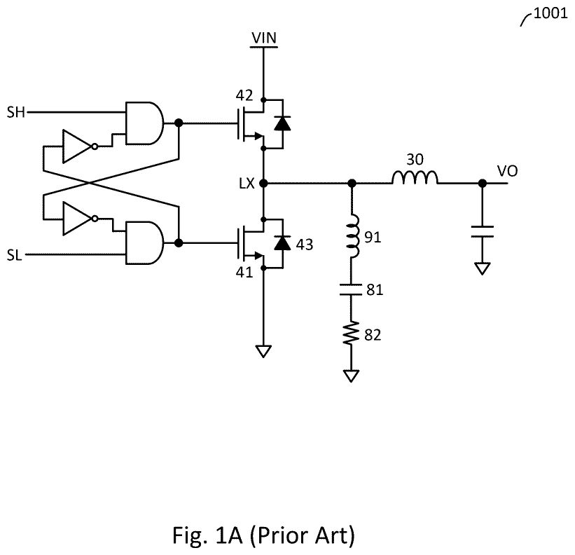

### DESCRIPTION OF THE PREFERRED EMBODIMENTS

The drawings as referred to throughout the description of the present invention are for illustration only, to show the interrelations between the circuits and the signal waveforms, but not drawn according to actual scale of circuit sizes and signal amplitudes and frequencies.

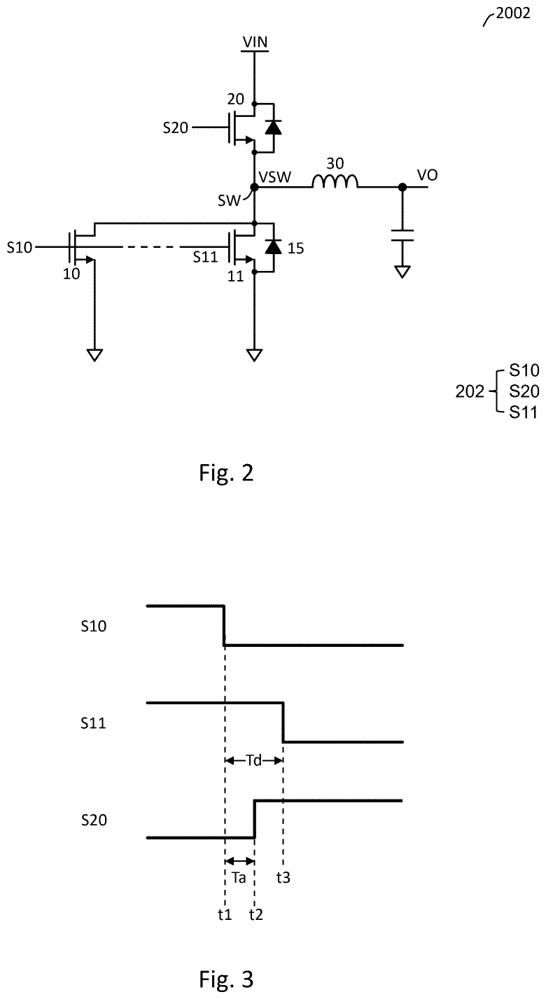

FIG. 2 illustrates a schematic diagram of a switching converter in one embodiment of the present invention. In one embodiment, a control circuit 202 is configured to reduce reverse recovery charge in a switching converter 2002; more specifically, the reverse recovery charge refers to reverse recovery charge of a body diode 15 of a first transistor 10, the details of which will be described later. In one embodiment, the control circuit 202 includes a first control signal S10, a second control signal S20, and an auxiliary control signal S11.

In one embodiment, the first control signal S10 is configured to switch the first transistor 10, the second control signal S20 is configured to switch a second transistor 20, and the auxiliary control signal S11 is configured to switch an auxiliary transistor 11. In one embodiment, a first terminal and a second terminal of the first transistor 10 are coupled in parallel to a first terminal and a second terminal of the auxiliary transistor 11. Specifically, in this embodiment, a drain and a source of the first transistor 10 are coupled in parallel to a drain and a source of the auxiliary transistor 11. In one embodiment, the first transistor 10 and the second transistor 20 are jointly coupled to a switching node SW and are configured to periodically switch an inductor 30 so as to convert an input voltage VIN into an output voltage VO. In one embodiment, the first transistor 10, the second transistor 20, and the auxiliary transistor integrated in a chip. In this embodiment, the first transistor 10, the second transistor 20, and the auxiliary transistor 11 are all NMOS transistors.

In this embodiment, as shown in FIG. 2, a power-stage circuit in the switching converter 2002 includes the first transistor 10, the second transistor 20 and the inductor 30, and is configured as a synchronous buck converter. The first transistor 10 is configured as a low-side transistor, and the second transistor 20 is configured as a high-side transistor. It should be noted that the following description takes the power-stage circuit configured as a synchronous buck converter as an example of the present invention. In other embodiments, the power-stage circuit may be configured in other topologies.

FIG. 3 illustrates operating waveforms of the control circuit in one embodiment of the present invention. In one embodiment, a delay time Td elapses from disabling the first control signal S10 at a time t1 to disabling the auxiliary control signal S11 at a time t3. Stated differently, after the first control signal S10 is disabled (turning off the first transistor 10), the auxiliary control signal S11 is disabled after the delay time Td. In one embodiment, the auxiliary control signal S11 is disabled (turning off the auxiliary transistor 11) after the second control signal S20 is enabled at a time t2 (turning on the second transistor 20). In one embodiment, a dead time Ta exists between the first control signal S10 and the second control signal S20. During the dead time Ta, both the first control signal S10 and the second control signal S20 are disabled.

Please refer to FIG. 2 together with FIG. 3. In one embodiment, in order to prevent the body diode 15 from accumulating excessive reverse recovery charge while it is forward-conducting, the auxiliary transistor 11 remains ON during the dead time Ta and at the time t2 when the second control signal S20 is enabled, and is disabled at an appropriate moment so as to effectively reduce the reverse recovery charge and suppress a voltage spike at the switching node SW.

It should be noted that, in the prior art, because the body diode 15 of the first transistor 10 accumulates a large amount of reverse recovery charge while it is forward-conducting during the dead time Ta, when the second control signal S20 is enabled at the time t2 at the end of the dead time Ta, the reverse recovery charge must be removed (or recombined) to drive the diode into reverse blocking, which causes a voltage spike of a switching voltage VSW at the switching node SW. The present invention avoids conduction of the body diode 15 or reduces its forward current by enabling the auxiliary control signal S11. Therefore, by disabling the auxiliary control signal S11 after the second control signal S20 is enabled, the present invention avoids or reduces an effect of reverse recovery charge of the body diode 15 of the first transistor 10, thereby avoiding or reducing the voltage spike of the switching voltage VSW at the switching node SW caused by the reverse recovery charge.

It should also be noted that, in one embodiment, the first transistor 10 and the auxiliary transistor 11 are formed on a same substrate, and the first transistor 10 and the auxiliary transistor 11 respectively correspond to respective portions of a transistor array on the substrate. Specifically, the first transistor 10 corresponds to a portion of a transistor array on the substrate, and the auxiliary transistor 11 corresponds to another portion of the transistor array. Accordingly, in this embodiment, the body diode 15 of the first transistor 10 is also a body diode of the auxiliary transistor 11.

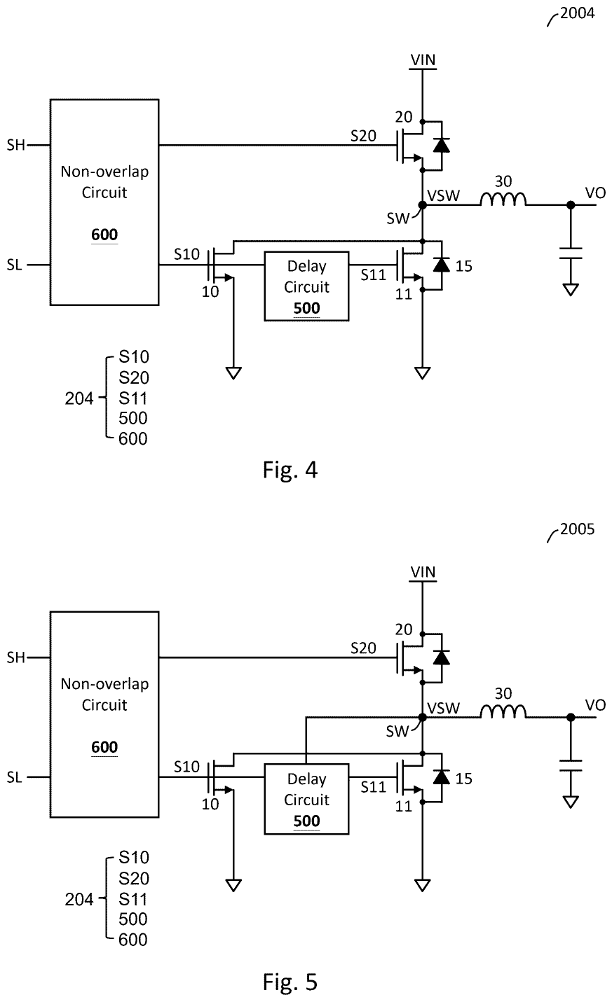

FIG. 4 illustrates a circuit block diagram of a switching converter in one embodiment of the present invention. A switching converter 2004 of FIG. 4 is one embodiment of the switching converter 2002 of FIG. 2. In one embodiment, a control circuit 204 in the switching converter 2004 further includes a delay circuit 500 and a non-overlap circuit 600. In one embodiment, the non-overlap circuit 600 is configured to generate the first control signal S10 and the second control signal S20 from a control signal SH and a control signal SL. The non-overlap circuit 600 is further configured to control the dead time Ta between the first control signal S10 and the second control signal S20. In one embodiment, the delay circuit 500 is configured to delay the first control signal S10 so as to generate the auxiliary control signal S11 with the delay time Td. For details not described, please refer to FIGS. 2 and 3.

FIG. 5 illustrates a circuit block diagram of a switching converter in another embodiment of the present invention. A switching converter 2005 of FIG. 5 is another embodiment of the switching converter 2002 of FIG. 2. The switching converter 2005 of FIG. 5 is similar to the switching converter 2004 of FIG. 4 and differs in that the delay circuit 500 of FIG. 5 is further coupled to the switching node SW so as to adaptively adjust the delay time Td according to a switching voltage VSW at the switching node SW. For details not described, please refer to FIGS. 2, 3, and 4.

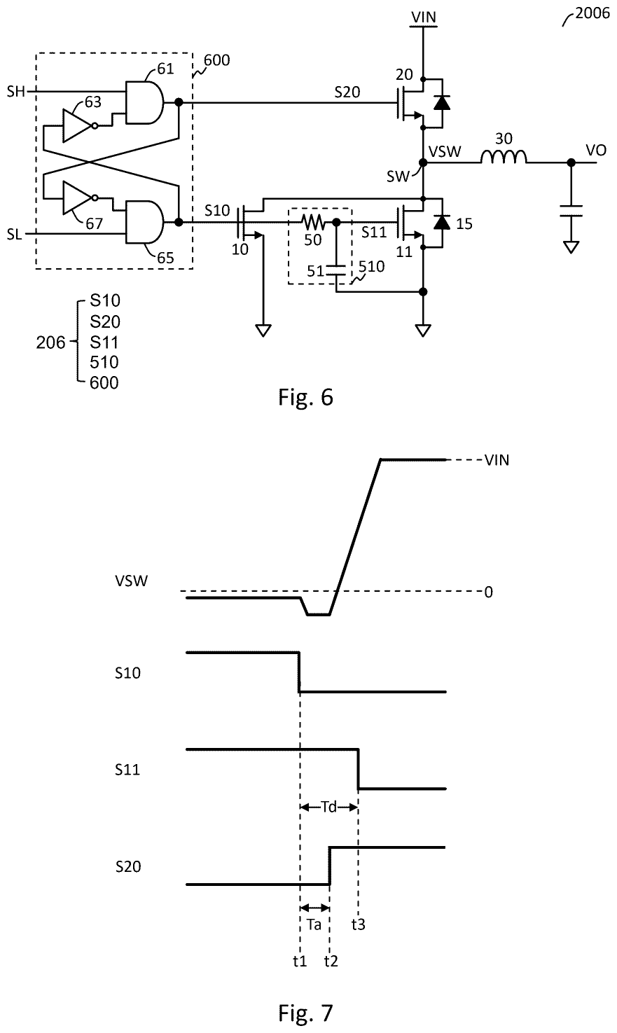

FIG. 6 illustrates a schematic diagram of a switching converter in a specific embodiment of the present invention. A switching converter 2006 of FIG. 6 corresponds to a specific embodiment of the switching converter 2004 of FIG. 4. In the embodiment of FIG. 6, a control circuit 206 in the switching converter 2006 includes the first control signal S10, the second control signal S20, the auxiliary control signal S11, a delay circuit 510, and the non-overlap circuit 600. In one embodiment, the non-overlap circuit 600 includes logic gates (e.g., an AND gate 61 and an AND gate 65) and inverters (e.g., an inverter 63 and an inverter 67), and is configured to control the dead time Ta between the first control signal S10 and the second control signal S20 so as to avoid a situation where the second transistor 20 (the high-side transistor) and the first transistor 10 (the low-side transistor) are simultaneously ON.

In one embodiment, the delay circuit 510 includes a delay resistor 50 and a delay capacitor 51 so as to delay the first control signal S10 and thereby generate the auxiliary control signal S11 with a delay time Td. In this embodiment, the delay time Td is determined according to the delay resistor 50. In one embodiment, after the first control signal S10 is disabled, the auxiliary control signal S11 remains enabled for a period due to the delay time Td, so that the auxiliary transistor 11 stays ON. Consequently, when the second transistor 20 turns on, reverse recovery charge of the body diode 15 is avoided or substantially reduced.

It should be noted that in one embodiment, an on-resistance value of the auxiliary transistor 11 is at least five times greater than an on-resistance value of a first transistor 10. In another embodiment, the on-resistance value of the auxiliary transistor 11 is at least ten times greater than the on-resistance value of a first transistor 10. In one embodiment, the on-resistance value of the auxiliary transistor 11 is greater than a lower resistance limit such that, during a period in which the second transistor 20 and the auxiliary transistor 11 may both be ON, a current flowing through the auxiliary transistor 11 is less than a predetermined current value, thereby reducing forward current of the body diode 15 (if any) while avoiding excessive power loss. In one embodiment, the on-resistance value of the auxiliary transistor 11 is inversely related to a reverse recovery charge value of the body diode 15 of the first transistor 10.

In an optional embodiment, the on-resistance value of the auxiliary transistor 11 is less than an upper resistance limit, thereby preventing conduction of the body diode 15 of the first transistor 10; thus, no reverse recovery charge is accumulated during the dead time, and the voltage spike caused by clearing the reverse recovery charge is avoided. For other details not described with respect to FIG. 6, please refer to the foregoing embodiments.

FIG. 7 illustrates operating waveforms of the control circuit corresponding to FIG. 6 in one embodiment of the present invention. In one embodiment, while the first control signal S10 is enabled (before the time t1), the switching voltage VSW is generally close to ground potential (or slightly below zero, depending on load conditions). When the control circuit enters the dead time Ta, both the first control signal S10 and a second control signal S20 are disabled, and the switching voltage VSW further decreases. During the dead time Ta, an inductor current (e.g., free-wheeling current) flows through the body diode 15 of the first transistor 10 or through the auxiliary transistor 11. When the second control signal S20 is enabled at the time t2, the switching voltage VSW gradually rises toward the input voltage VIN. At the time t2, the auxiliary control signal S11 remains enabled, so that the inductor current continues to flow through the auxiliary transistor 11, thereby reducing or avoiding reverse recovery charge of the body diode 15 and suppressing voltage spike of the switching voltage VSW. In this embodiment, the auxiliary control signal S11 is disabled after the delay time Td expires at the time t3 according to the control of the delay circuit 510. In a preferred embodiment, the delay time Td is longer than the dead time Ta.

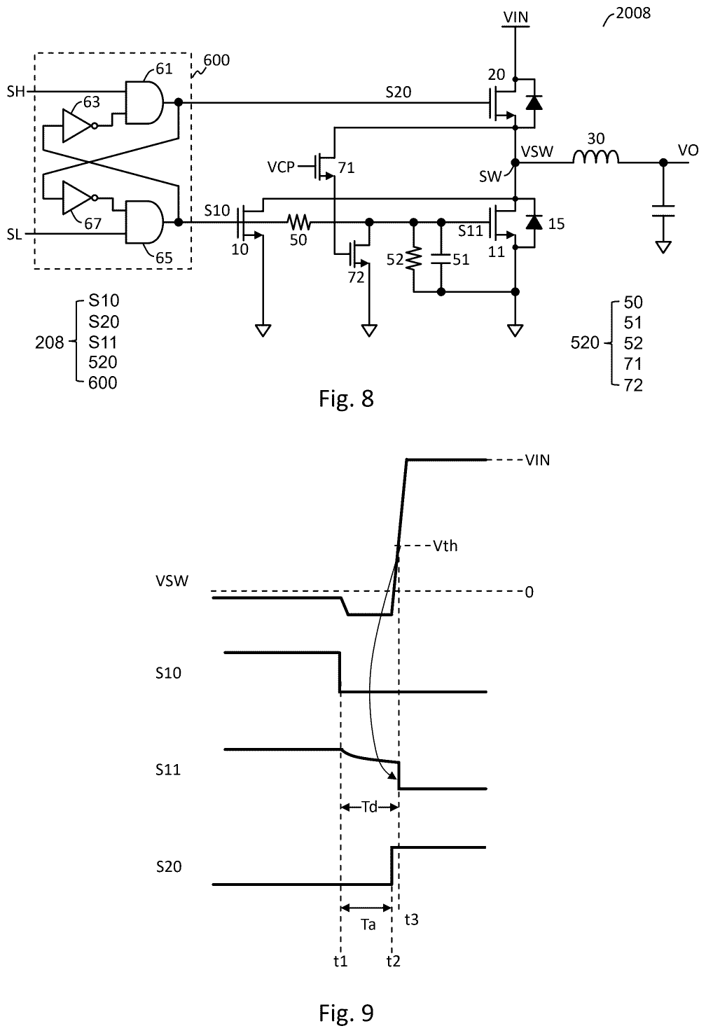

FIG. 8 illustrates a schematic diagram of a switching converter in another specific embodiment of the present invention. A switching converter 2008 of FIG. 8 corresponds to a specific embodiment of the switching converter 2005 of FIG. 5. In the embodiment of FIG. 8, a control circuit 208 of the switching converter 2008 includes the first control signal S10, the second control signal S20, the auxiliary control signal S11, a delay circuit 520, and the non-overlap circuit 600. In one embodiment, the delay circuit 520 includes the delay resistor 50, the delay capacitor 51, a delay resistor 52, a voltage-clamp transistor 71, and a control transistor 72. In a specific embodiment, the voltage-clamp transistor 71 and the control transistor 72 are both NMOS transistors. The voltage-clamp transistor 71 operates according to a bias voltage VCP. The source of the voltage-clamp transistor 71 is coupled to a gate of the control transistor 72 so as to clamp a gate voltage of the control transistor 72 to no more than a clamp voltage, which is approximately the bias voltage VCP minus a gate-to-source threshold voltage of the voltage-clamp transistor 71. A drain of the control transistor 72 is coupled, through the voltage-clamp transistor 71, to the switching node SW so as to receive the switching voltage VSW. Thus, the control transistor 72 is driven by the switching voltage VSW while being isolated from full magnitude of the switching voltage VSW.

Please refer also to FIG. 9. FIG. 9 illustrates operating waveforms of the control circuit corresponding to FIG. 8 in one embodiment of the present invention. In one embodiment, when the second control signal S20 is enabled and the switching voltage VSW exceeds (e.g., higher than) a predetermined threshold Vth at the time t3, the control transistor 72 turns ON, causing the auxiliary control signal S11 to be disabled so as to turn OFF the auxiliary transistor 11. In this embodiment, an end of the delay time Td is adaptively determined by the switching voltage VSW. More specifically, the switching voltage VSW transitions (in this embodiment, rises) in response to enabling of the second control signal S20, and when the switching voltage VSW exceeds the predetermined threshold Vth, the auxiliary control signal S11 is disabled. In a specific embodiment, the predetermined threshold Vth corresponds to a gate-to-source threshold voltage of the control transistor 72 (e.g., 0.7 V). For details not described with respect to FIGS. 8 and 9, reference is made to the foregoing embodiments.

It should be noted that, in the foregoing embodiments, a transition time of the switching voltage VSW at the switching node SW-that is, the time required for the switching voltage VSW to rise to the input voltage VIN in response to enabling of the second control signal S20-is shortened because reverse recovery charge of a body diode 15 is avoided or reduced. In one embodiment, by means of the mechanism that adaptively adjusts the delay time Td according to the switching voltage VSW, a propagation delay from the switching voltage VSW exceeding the predetermined threshold Vth to turn-off of the auxiliary transistor 11 is less than 2 ns. Accordingly, in the embodiments of FIGS. 8 and 9, the loss caused by short-circuit current between the auxiliary transistor 11 and the second transistor 20 is greatly reduced.

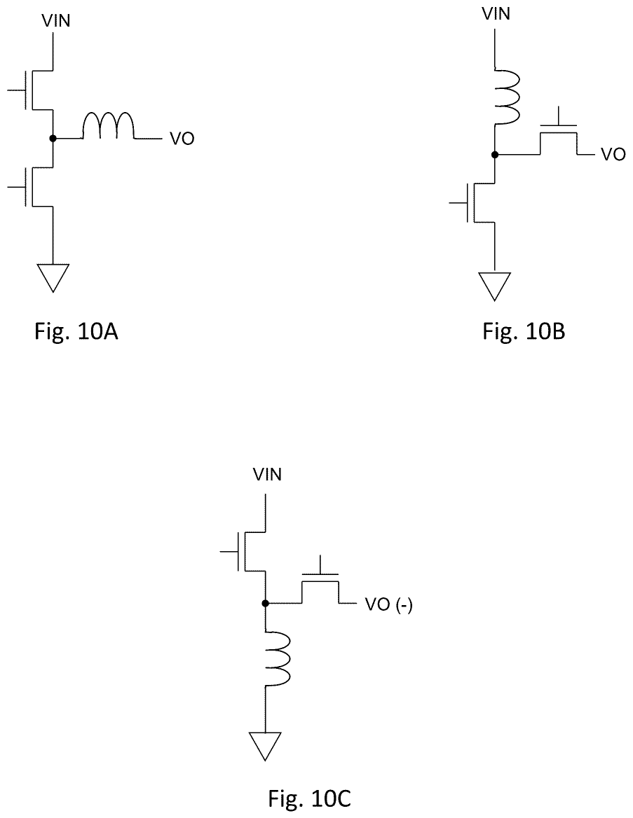

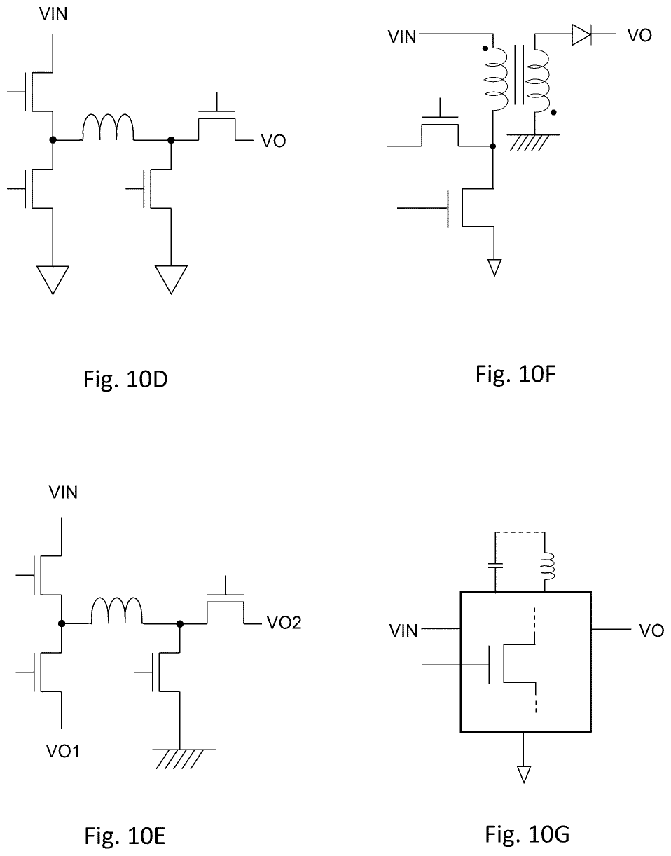

FIGS. 10A to 10G illustrate various embodiments of a power-stage circuit of the switching converter of the present invention. The power-stage circuit of the switching converter of the present invention includes at least one switch and an inductor coupled to each other, wherein the at least one switch switches the inductor according to a control signal so as to convert the input voltage into the output voltage. As shown in FIGS. 10A to 10G, the power-stage circuit may be, but not limited to, a synchronous buck converter, a synchronous boost converter, a buck-boost converter, a half-bridge flyback converter, or a full-bridge or half-bridge switched-resonant converter.

The present invention has been described in considerable detail with reference to certain preferred embodiments thereof. It should be understood that the description is for illustrative purpose, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment. In view of the foregoing, the spirit of the present invention should cover all such and other modifications and variations, which should be interpreted to fall within the scope of the following claims and their equivalents.

What is claimed is:

1. A control circuit for reducing reverse recovery charge in a switching converter, comprising:
a first control signal configured to switch a first transistor;
a second control signal configured to switch a second transistor; and
an auxiliary control signal configured to switch an auxiliary transistor;
wherein a first terminal and a second terminal of the first transistor are coupled in parallel to a first terminal and a second terminal of the auxiliary transistor;
wherein the first transistor and the second transistor are coupled to a switching node and configured to periodically switch an inductor so as to convert an input voltage into an output voltage; and
wherein a delay time elapses from disabling the first control signal to disabling the auxiliary control signal, and the auxiliary control signal is disabled after the second control signal is enabled.

2. The control circuit of claim 1, wherein the first transistor, the second transistor, and the auxiliary transistor are integrated in a single chip.

3. The control circuit of claim 1, further comprising a delay circuit configured to delay the first control signal so as to generate the auxiliary control signal with the delay time.

4. The control circuit of claim 1, wherein the delay time is determined according to a delay resistor.

5. The control circuit of claim 1, wherein the first transistor and the auxiliary transistor are formed on a same substrate, and the first transistor and the auxiliary transistor respectively correspond to respective portions of a transistor array on the substrate.

6. The control circuit of claim 1, wherein an on-resistance value of the auxiliary transistor is at least five times greater than an on-resistance value of the first transistor.

7. The control circuit of claim 1, further comprising a non-overlap circuit configured to generate a dead time between the first control signal and the second control signal, wherein both the first control signal and the second control signal are disabled during the dead time.

8. The control circuit of claim 1, wherein the first transistor, the second transistor, and the inductor are configured as one of: a synchronous buck converter, a synchronous boost converter, or a buck-boost converter.

9. The control circuit of claim 1, wherein an on-resistance value of the auxiliary transistor is less than an upper resistance limit, thereby preventing a body diode of the first transistor from conducting.

10. The control circuit of claim 1, wherein an on-resistance value of the auxiliary transistor is greater than a lower resistance limit such that a current flowing through the auxiliary transistor is less than a predetermined current value.

11. The control circuit of claim 1, wherein an on-resistance value of the auxiliary transistor is inversely related to a reverse recovery charge value of a body diode of the first transistor.

12. The control circuit of claim 1, wherein the auxiliary control signal is disabled after the second control signal is enabled, so as to avoid or reduce an effect of reverse recovery charge of a body diode of the first transistor.

13. The control circuit of claim 12, wherein a transition time of a switching voltage at the switching node is shortened due to avoidance or reduction of reverse recovery charge of the body diode.

14. The control circuit of claim 3, wherein a switching voltage at the switching node transitions in response to the second control signal being enabled, and the auxiliary control signal is disabled when the switching voltage exceeds a predetermined threshold.

15. The control circuit of claim 14, wherein the delay circuit further includes a control transistor configured to switch when the switching voltage exceeds the predetermined threshold so as to disable the auxiliary control signal.

16. The control circuit of claim 15, wherein the control transistor is coupled to a control terminal of the auxiliary transistor, the control transistor is controlled by the switching voltage, and the predetermined threshold corresponds to a gate-to-source threshold voltage of the control transistor.

17. The control circuit of claim 15, wherein the delay circuit further includes a voltage-clamp transistor coupled between the control transistor and the switching voltage and configured to clamp a voltage at a control terminal of the control transistor, thereby preventing the voltage at the control terminal from exceeding a clamp voltage.

18. A control method for reducing reverse recovery charge in a switching converter, comprising:
generating a first control signal configured to switch a first transistor;
generating a second control signal configured to switch a second transistor;
generating an auxiliary control signal configured to switch an auxiliary transistor, wherein a first terminal and a second terminal of the first transistor are coupled in parallel to a first terminal and a second terminal of the auxiliary transistor;
periodically switching an inductor according to the first control signal and the second control signal so as to convert an input voltage into an output voltage; and
controlling such that a delay time elapses from disabling the first control signal to disabling the auxiliary control signal, and disabling the auxiliary control signal after the second control signal has been enabled.

19. The control method of claim 18, further comprising:
delaying the first control signal so as to generate the auxiliary control signal with the delay time.

20. The control method of claim 18, wherein the delay time is determined according to a delay resistor.

21. The control method of claim 18, wherein an on-resistance value of the auxiliary transistor is at least five times greater than an on-resistance value of the first transistor.

22. The control method of claim 18, further comprising:
generating a dead time between the first control signal and the second control signal, wherein both the first control signal and the second control signal are disabled during the dead time.

23. The control method of claim 18, wherein an on-resistance value of the auxiliary transistor is less than an upper resistance limit, thereby preventing a body diode of the first transistor from conducting.

24. The control method of claim 18, wherein an on-resistance value of the auxiliary transistor is greater than a lower resistance limit such that a current flowing through the auxiliary transistor is less than a predetermined current value.

25. The control method of claim 18, wherein an on-resistance value of the auxiliary transistor is inversely related to a reverse recovery charge value of a body diode of the first transistor.

26. The control method of claim 18, wherein disabling the auxiliary control signal after the second control signal is enabled avoids or reduces an effect of reverse recovery charge of a body diode of the first transistor.

27. The control method of claim 26, wherein the first transistor and the second transistor are coupled to a switching node, and a transition time of a switching voltage at the switching node is shortened due to avoidance or reduction of reverse recovery charge of the body diode.

28. The control method of claim 18, wherein the first transistor and the second transistor are coupled to a switching node, and a switching voltage at the switching node transitions in response to the second control signal being enabled, wherein the control method further comprising:
disabling the auxiliary control signal when the switching voltage exceeds a predetermined threshold.
